(19) United States
(12) Patent Application Publication
(10) Pub. No.: US 2022/0358602 A1
(43) Pub. Date: Nov. 10, 2022

(54) INTENT ELICITATION IN DYNAMIC AND HETEROGENEOUS NETWORKS WITH IMPERFECT INFORMATION

(71) Applicant: WONDEREUR INC., Toronto (CA)

(72) Inventors: Bart GAJDEROWICZ, Toronto (CA); Vijay MAGO, Thunder Bay (CA)

(21) Appl. No.: 17/734,929

(22) Filed: May 2, 2022

Related U.S. Application Data
(60) Provisional application No. 63/182,545, filed on Apr. 30, 2021.

(51) Int. Cl. G06Q 50/00; G06N 20/00

(52) U.S. Cl. CPC G06Q 50/01; G06N 20/00

(57) ABSTRACT

In an embodiment, a computer-implemented method elicits intents of agents in a social network with imperfect information. In the method, data representing the social network is gathered. The social network includes a plurality of resources and a plurality of agents seeking to alter values of the resources. In an example, the resources may be artists, and the agents may be art institutions. The social network is represented as a graph including nodes representing the plurality of agents. The nodes are connected by edges specifying how resources are transferred between the agents. Based at least in part on the graph, an affinity value and a trajectory value between respective agents in the plurality of agents is determined. Based at least in part on the graph, the affinity value and the trajectory value are input into a trained machine learning model to identify a strategy of the plurality of agents.

### FIELD

The field of the invention is information technology and network analysis.

### BACKGROUND

In a complex network of interacting and rational agents, it is difficult to identify the agents that have most influence on the value of resources exchanged or used by the agents before they increase in value. At the same time, the decisions of agents in the past (downstream) have been known to have contributed greatly to the future (upstream) value of such resources. For example, in the art market, the value of an artist or a subset of their artwork increases or decreases based on their popularity, purchase history, state of the financial market, and the artist's exhibition history which includes the institutions they exhibited in, for how long, and whether it was a group or solo show, amongst other factors. When an artist exhibits at a highly valued institution, it is well established that their value will most likely increase, for the formidable future. Upstream nodes are those that exists at further points in paths in the graph, such as current or future exhibits at known institutions. However, there are many hidden factors downstream that contributed to the increasing value that occurred in the past. These include the personal connections art curators and art dealers have with other curators or institutions, the strategies curators and art dealers use to promote their artists, and art genres the viewing and buying public will be interested in.

Value assessment of resources with hidden historical factors downstream to predict future value upstream, like artists or artworks, is performed by experts in the field, who can incorporate required information using their knowledge and intuition built up over time. However, to perform such assessment at scale requires many such experts, each with their own bias, preferences, areas of expertise, and skill levels, introducing errors and inconsistencies in the final value assessment. To predict value of such resources at scale, and reduce before mentioned issues, a method is needed for computers to retrieve influential nodes and paths between influential nodes downstream and valuable nodes upstream, to predict their future value.

### BRIEF SUMMARY

In an embodiment, a computer-implemented method elicits intents of agents in a social network with imperfect information. In the method, data representing the social network is gathered. The social network includes a plurality of resources and a plurality of agents seeking to alter values of the resources. In an example, the resources may be artists, and the agents may be art institutions, such as galleries. The social network is represented as a graph including nodes representing the plurality of agents. The nodes are connected by edges specifying how resources are transferred between the agents. Based at least in part on the graph, an affinity value between respective agents in the plurality of agents is determined. The affinity value represents a degree to which the respective agents and agents surrounding the respective agents in the graph share common resources. Based at least in part on the graph, a trajectory value between respective agents in the plurality of agents is determined. The trajectory value represents a likelihood that a first agent in the plurality of agents presented a resource subsequent to a second agent in the plurality of agents. The affinity value and the trajectory value are input into a trained machine learning model to identify a strategy of the plurality of agents. The strategy includes at least one goal.

The trajectory with the highest weight, as determined by the machine learning module, is a novel and enhanced case of time-dependent shortest path (TDSP). The application of TDSP extensions is to retrieve the optimal path given some scenario that match the domain and decisions made by rational agents that maximize their utility. The novel and enhanced case presented here is a time-history-neighborhood-novelty-dependent shortest path, or THNDSP. THNDSP incorporates known constraints about the timing, history, neighborhood, and novelty factors that occur downstream, but contribute to the value of a resource upstream.

The result is a shortest-path retrieval method that imposes THND constraints and reduces the state space to a tractable size. The retrieved THND shortest path begins with nodes that are influential downstream and ends with nodes that are benefiting from the upstream growth of a resource's value.

Descriptions provided in the summary section represent only examples of the embodiments. Other embodiments in the disclosure may provide varying scopes different from the description in the summary.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a flowchart illustrating a method for determining intent in a dynamic and heterogeneous network with imperfect information.

FIG. 2 is a more detailed sub-process pipeline that calculates the fitness of a model for intent elicitation and a dynamic network.

FIG. 3A is an example diagram illustrating a bipartite graph between agent nodes and resource nodes used to calculate usage and neighborhood values.

FIG. 3B is an example diagram illustrating a directed graph between agent nodes where edges represent all possible sharing of resource across the network, typically used to calculate centrality measures of the graph and retrieve important nodes in the network.

FIG. 3C is an example diagram illustrating a directed graph between agent nodes where edges represent the sharing of a particular resource across the network, and the time point when the sharing occurred. The highlighted edges represent the retrieved THND shortest path that makes up the causal chain inferred by the invention.

FIG. 3D is an example diagram illustrating the steps agents take to share a resource, the time points of each share-step, and neighborhoods within which sharing occurs.

FIG. 4 illustrates an exemplary computer system capable of implementing the methods illustrated in FIGS. 1-3.

In the drawings, like reference numbers generally indicate identical or similar elements. Additionally, generally, the left-most digit(s) of a reference number identifies the drawing in which the reference number first appears.

### DETAILED DESCRIPTION

In computer science, network theory is the study of graphs as a representation between discrete objects. A network can be defined as a graph with nodes connected by edges. The study of how networks change over time is known as network dynamics. The changes may be to the structure of connections of the units of a network, to the collective internal state of the network, or both. Such network representations could be from the fields of biology, chemistry, physics, sociology, economics, and information technology. When causal factors are known, the more accurate prediction can be made by identifying a sequence of events that caused or at least significantly contribute to the probability that an event will occur in the future.

System designers, when retrieving information about the behavior of agents in a network, are often interested in the most influential nodes in the network and calculate centrality measures of each node with the highest measure identifying the most influential node. Many such metric exists, such as centrality measures, influence networks, conformity analysis, and so on. However, such measures identify upstream influencers, such as those with high closeness centrality or betweenness centrality, or ones that form clusters of homogeneous groups around themselves. Other methods rely on the number of connections such as degree and page rank. However, this information does not allow for directional flow of information distribution, such as value dissemination. Without direction, downstream or upstream influence is difficult to retrieve.

While attempting to understand influence downstream, except under specific conditions, a high degree of information diffusion occurs. In other words, the influence of nodes becomes intractable as entities propagate through the network and change states. In large networks, a steady state of influence weight is hard to determine as convergence to an equilibrium with non-zero weights may be not possible. Systems and methods are needed that converge more easily to identify the influence of various nodes.

For time-series data represented as a graph, system designers often rely on transition matrices to find influence of nodes in a network. A transition matrix is a square matrix that gives the probabilities of different resources going from one state to another calculated form previous state transitions over time. The greater the probability the greater the chance a resource will transition to a state. In a network topology, certain nodes may have more influence on the states of entities, and how those entities change states from one time point to the next.

Another approach is shortest path analysis that allows system designers to retrieve the shortest path between two nodes. The shortest path is a path between two nodes with the minimum number of edges between the nodes. Shortest paths are used to calculate closeness and betweenness centralities.

Additional properties can be added to model particular scenarios. For example, time-dependent shortest path analysis retrieves the shortest path given time constraints, such as waiting time at each node or minimum time spent traversing edges, or sequence constraints such as first-in-first-out networks where agents arriving at the same node must leave in the order of arrival. Various time-constraints and delay-tolerance scoring schemes extend the basic analysis to model a particular domain.

Embodiments allow for understanding of the effect of value makers (such as influencers or, in the art market, art institutions) more efficiently and with noisy and incomplete data. As mentioned above, using conventional techniques, the ability to be effective individual value makers tends to get diluted very quickly. As a result, it is difficult to tell who actually or intentionally contributed to a change in an asset's value. Embodiments allow for identification of these value makers efficiently and with imperfect data.

Embodiments build paths over time to identify the particular value maker is good at changing value in a particular population. Moreover, embodiments identify particular strategies that value makers use to change the assets value. In the example of art institutions, embodiments identify particular strategies that art institutions used to improve the value of work produced by particular artists. For example, some artists provide exposure to a large number of institutions with different audiences to achieve a wide breadth, while other artists tend to focus on getting deep exposure for a particular audience, getting exposure at possibly institutions that focus on that particular audience. So some embodiments identify not just the value makers, but also the strategies used between the various value makers to achieve a change in value.

Knowing network dynamics allows for prediction of the future state of its nodes (the agents, for example art institutions like museums, galleries, or auction houses); testing future what-if scenarios; testing counterfactual scenarios; identifying influential nodes in the network; identifying preferences and objectives of nodes in the network, identifying value of each node and its edges (resources used and propagated through the network, for example artists or artworks that are exhibited at different art institutions over time).

Embodiments provide a heterogeneous network of agents (represented as nodes) and resources (represented as edges) to help understand influence in a dynamic environment (e.g., which agent and resources have the most impact on the state of the network and any inherent utility the state provides to each agent and resource). Embodiments also help understand information diffusion (e.g., the probability of an artist being in one art institution or a groups of art institutions, after some time) amongst heterogeneous agents (e.g. institutions differ in type, location, genre, portion of artist type, etc.) and resources (e.g., artists differ in demographic, genre, skill, social relationships, etc.), infer casual factors from sharing of resources, show intent of autonomous agents, show objectives of autonomous agents, and show approximate cause/effect of reflexive agents.

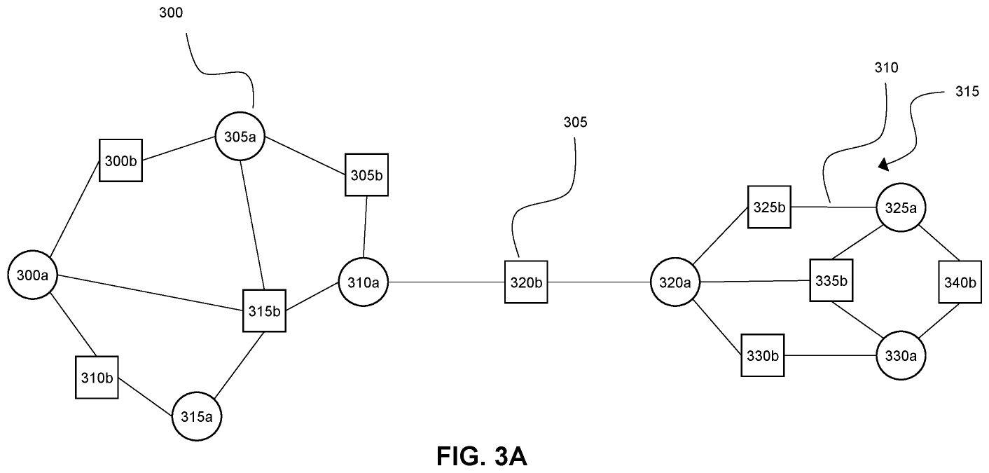

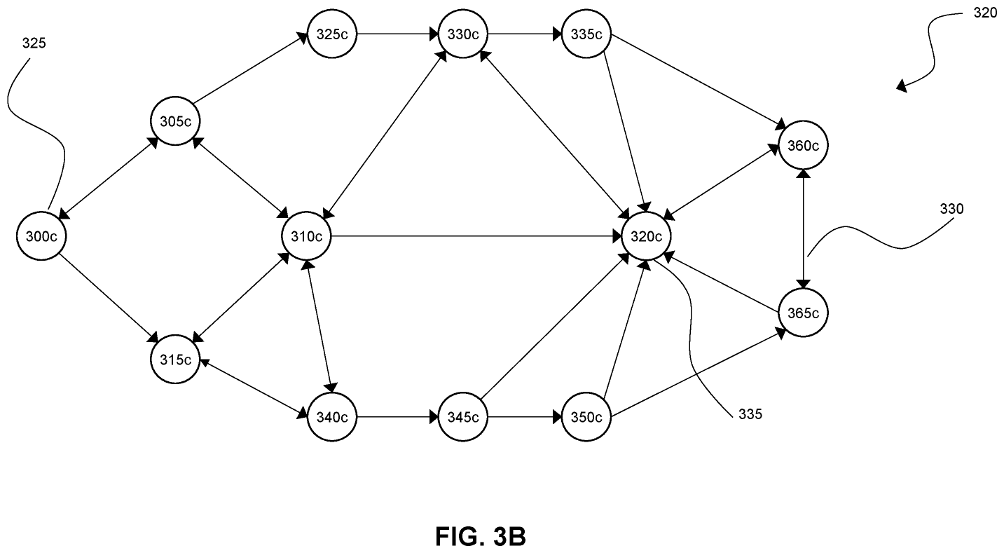

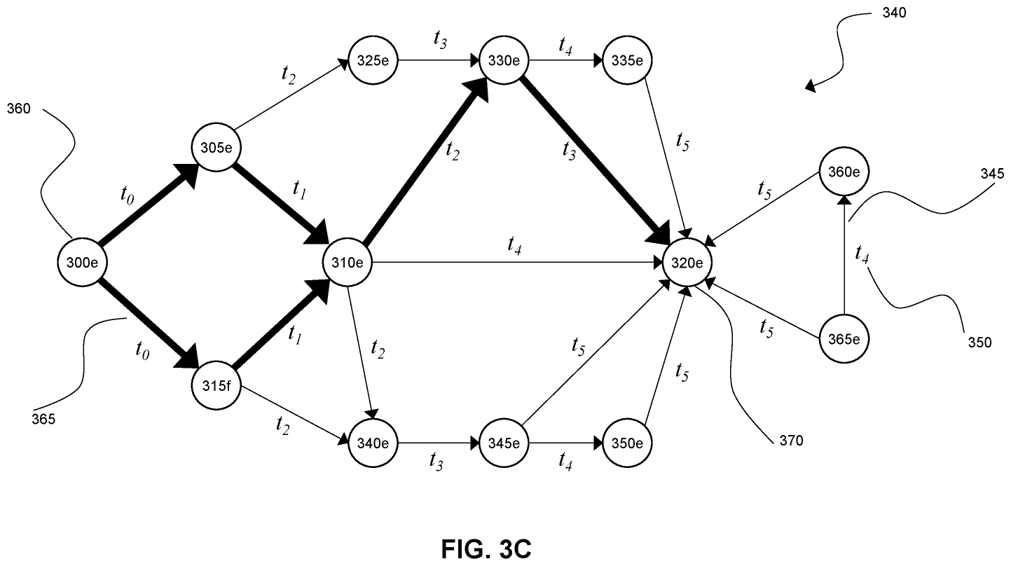

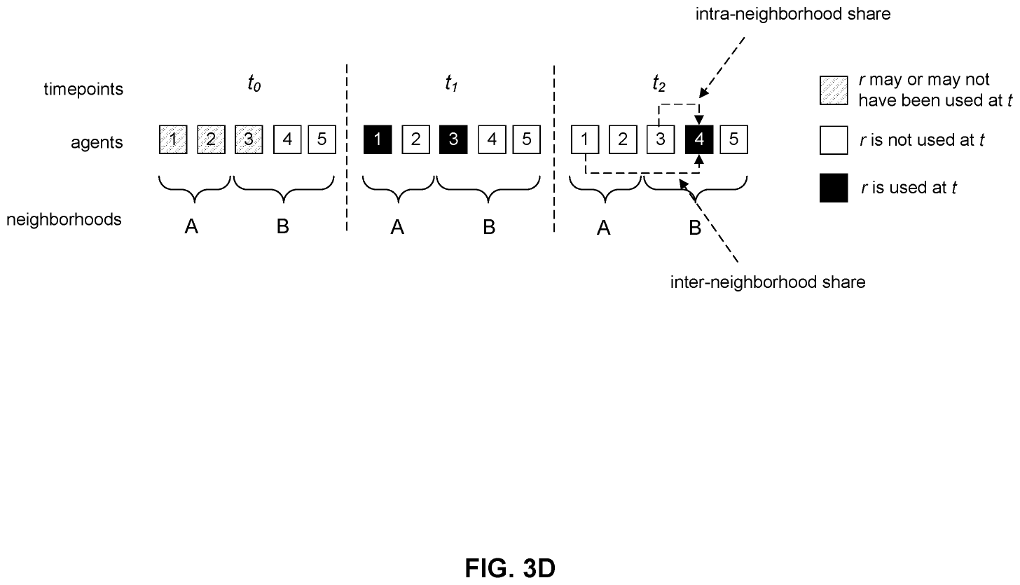

As mentioned above, data describing social and biological systems is noisy. Interdependence between nodes is complex and unknown directly. Entropy quickly dilutes impact of individual nodes. It is difficult to control and experiment with such systems. It is also difficult to reverse engineer causal factors, predict automatically if data is missing, and simulate if causal factors are missing. Consider the directed graph 320 depicted in FIG. 3b. Here, nodes represent agents (300c-365c) and edges 330 represent flow of resources between agents over time. Using current techniques on a network of small size and limited interconnectedness, it may be tractable to identify nodes 320c as the most influential 335, by calculating its centrality measure, which most typically focus on the upstream nodes 335. It may also be possible to identify node 300c as least influential 325 by calculating a low centrality score, as it is a downstream node.

However, in some application domains, especially socially dependent networks, such as the art market, having the highest centrality does not predict that a resource will reach the most influential node, only that they aspire to. Here, downstream nodes 325 are most influential, especially in the early careers of artists, and it is important to identify the causal chains and the first downstream nodes that initiate such causal chains.

A causal chain is depicted in FIG. 3c as a directed graph where agents are nodes (such as art institutions), edges 345 are the act of sharing a resource r between nodes, edge labels 350 is the time period at which the resource was shared between nodes, highlighted edges 365 identify the causal chain (THNDSP), 360 is the first node of the chain, and 370 is the last node of the chain. In this scenario, 360 is the most influential node as it begins the highlighted casual chain. The chain delivers some resource r at the earliest time to node 320e, namely at time t₃. Here, reaching node 320e is the objective as it has the highest centrality based on its place in the graph.

Improved systems and methods are needed to conduct such network analysis to retrieve such causal chains from a given network, when such a network is very large and data is missing, such as when causal factors cannot be inferred and when causal factors are missing, and synthetic data cannot be generated through simulation. Embodiments provide for this improvement through better definition of intentional sharing of resources between intentional social agents, better approximation of cause/effect relations from indirect observations of reflexive agents, better clustering of nodes based on retrieved intent, where clusters represent interdependencies, and better measure of influence when separating intentional sharing of resources from coincidental passing of resources, highlighting intention and foresight on the part of the sharer agent.

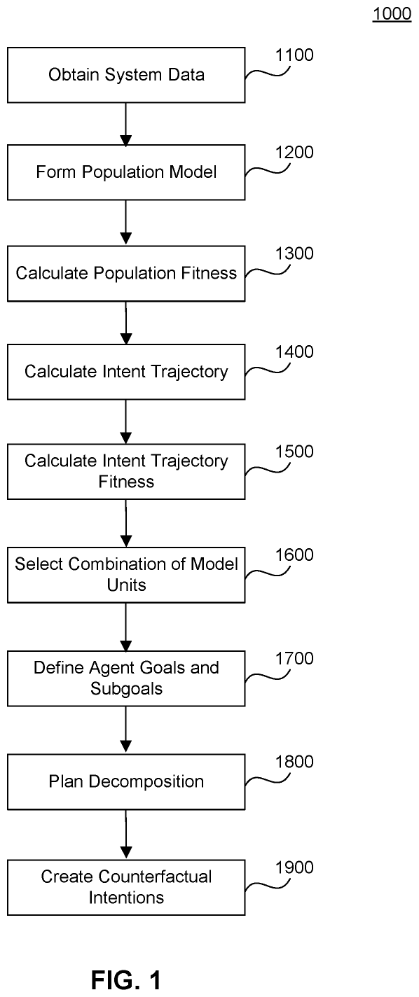

FIG. 1 is a flowchart illustrating a method 1000 for determining intent in a dynamic and heterogeneous network with imperfect information.

Method 1000 begins at step 1100 where system data is retrieved. The data retrieved may represent agents and resources. For example, the agents may be institutions, and resources may be artists. To retrieve the system data, the World Wide Web may be crawled and/or searched. Natural language processing techniques may be used to extract institutions and artists, and events (such as exhibitions, etc.) they have participated in and the time that those events occurred. In an example, these various data points may be stored in a persistent database.

Step 1100 may involve extracting, transforming, and loading data. For example, artists and institutions may be de-duplicated and stored in a computer-readable format. The ranking of nodes can be calculated from the graph itself by calculating centrality of nodes in a directed graph, like the graph 320 depicted in FIG. 3b, and retained. For example, having a high centrality may indicate that other nodes aspire to send their resources to that node, giving resource that reach it a higher value. If available, additional information about nodes is retained, such as the fact that museums have higher ranking than small galleries. Next, artist exhibitions can be labeled as “group” or “solo” with solo exhibitions having a higher ranking, and this data is saved in a computer-readable format. If available, resource value or ranking assignment v(r) is retained. For example, the resource value or ranking assignment may be the acclaim or popularity of an artist, or the provenance of their artworks. If available, resource value or ranking assignment vᵢ(r) for a resource r used by agent i is retained. For example, store the acclaim or popularity of artworks and associate it with the institution exhibiting the artists. If available, resource value or ranking assignment v(Rᵢ)=Σ_{r∈R}_{ᵢ}vᵢ(r) for all resources Rᵢ used by agent i is retained. The value of resources shared by a pair of agents i and j is v(Rᵢ∪Rⱼ), where Rᵢ, Rⱼ⊆R. For example, the value of an institution may be calculated based on the combined acclaim or popularity of all artists they exhibit, or the provenance of the artworks exhibited at the given institution.

At step 1200, a population model is formed. To form the population model, the obtained data is converted into a bipartite graph 315, as depicted in FIG. 3a, with agents (300a to 335a) and resources (300b to 340b) as nodes. A bipartite graph is a graph whose nodes can be divided into two disjoint and independent sets, such that edges connect nodes between the two disjoint and independent sets. In this case, the agents 300 are in one set, and the resources 305 are in another, and the edges 310 connect the two sets of nodes. In the example relating to the art market, the agents may be institutions, the resources may be artists, and the edges that connect them may be events, such as exhibitions where the institution exhibited the artist.

The edges of the bipartite graph 315 are occurrences of an agent using a resource at a given time point t. A separate bipartite graph is formed for each time point t. The ranking of each resource is retained when represented in the bipartite graph. The time points may be for example at regular intervals, such as weekly, monthly, yearly. The intervals may be frequent enough to observe trends in the relevant field, such as the art market.

Embodiments infer relationships between a set of agents that share a set of resources. An agent set is represented as i∈I. Resources are represented as r∈R. A time point t is defined. A set of time points t₀, t₁, t₂, . . . , t_{T} are ordered time points for some t-τ, where t₁<t₂< . . . r_{T-1}<r_{T}, is some period of time, where t-τ≥0. Each time point has a length τ, with a lower-bound and an upper-bound.

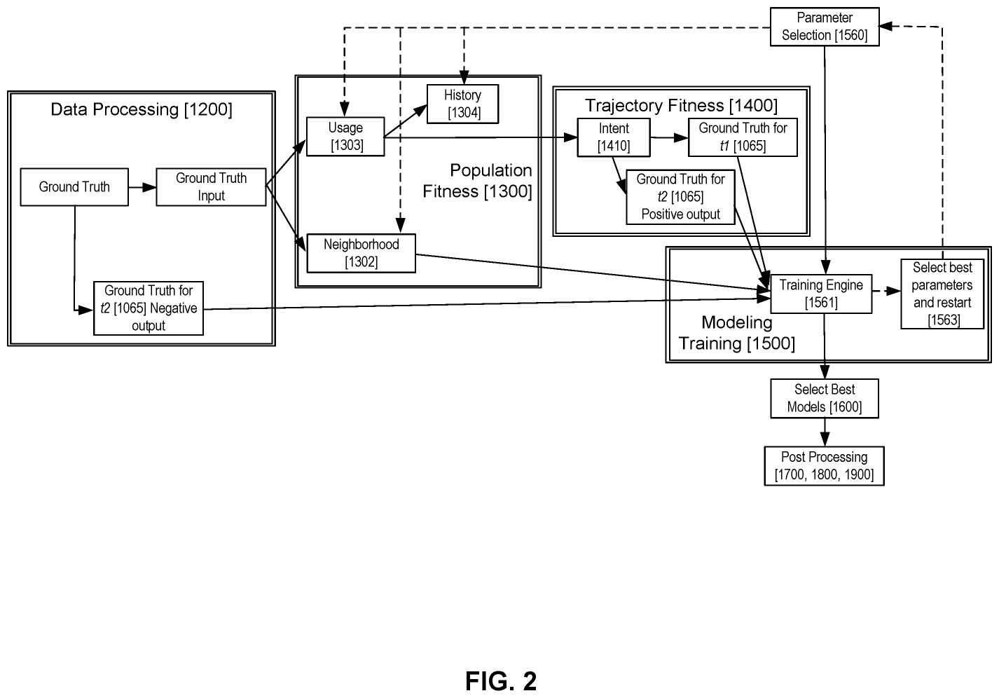

As shown in FIG. 2, the data retrieved at step 1100 (the ground truth) may be divided into two sets. One is used for the population fitness model as will be described below with respect to step 1300. Another will be used for model training as will be described below with respect to step 1500.

At step 1300, a population fitness is calculated. As shown in FIG. 2, the population fitness may involve three calculations. First is generation of a series of usage matrices at 1303. Second is generation of a history of fitness values assigned to historical usage of resources by agents at 1304. Third is generation of a neighborhood at 1302.

For a given time point tₓ, agent neighborhoods are calculated with respect to resources, using the bipartite 315 representation in FIG. 3a. This assigns a fitness to how close two agents are during tₓ. In addition, for a given time point t, resource usage is calculated by an agent. This may be done using one-hot encoding.

As shown in the equation below, Π(t) is a R×I one-hot encoding matrix for the usage of resources r∈R by agents iÅI. A one-hot encoding is a representation of categorical variables as binary vectors. For example, with a piece of art, i is the institution, and r is the artist. Π(t) represents a matrix where each element is one if the institution for that element has shown the artist for that element at time t and zero if the institution for that element has not shown the artist for that element at time t. In this case, Π(t) for time points t, is:

$$Usage$$

$$Π ( t , r , i ) = \{ \begin{matrix}1 ; & if r is used by i at t \\ 0 ; & otherwise\end{matrix}$$

In this way, a usage matrix for each time point t is generated.

From the usage value, a history value is determined. H(tₓ, r, j) is the fitness value assigned to historical usage of resource r by agents i and j in past time point tₓ₋₁, where tₓ<tₓ₋₁. A higher fitness occurs when agent j does not use the resource r for which fitness is being calculated at time point tₓ. The time points and resource usage by agents are illustrated in FIG. 3c.

### History

H(tₓ₋₁, r, j)=Π(tₓ, r, i)∘(I_31 _529 (tₓ₋₁,r, j))

In the context of art galleries, r represents artists and i and j represent different institutions. H(tₓ₋₁, r, j) indicates whether an artist was shown at gallery i at tₓ but was not previously shown at gallery j at tₓ₋₁. This allows the model to include first-time use of a resource by an agent and exclude the re-use of a resource by an agent. The use of a resource is considered a re-use by the receiving agent if the resource was used during tₓ₋₁ and tₓ. If the lower-bound of tₓ₋₁ is infinity, the resource r was never used by agent j that is receiving the resource.

In this way, embodiments isolate the earlier adopters in contrast to later adopters. For later adopters, there is a greater likelihood that the reason they are exhibiting the artist is because the earlier adopter had already exhibited the same artist. This is brought out with respect to the trajectory fitness to be discussed below.

In addition to the usage and history values, a neighborhood is determined at 1302. To determine a neighborhood, an affinity between each agent and each resource is calculated. It may represent the influence that a particular artist has on an institution, or a likelihood that the artist is exhibited at a particular institution.

In one example, the affinity may be determined using page rank, using a a representation of the network as a bipartite graph 315 in FIG. 3a. Page rank is known as a way of measuring the importance of website pages, which can be prioritized for particular search terms, by counting the number and quality of links to a page to determine a rough estimate of how important the website is. The underlying assumption is that more important websites are likely to receive more links from other websites. In other examples, affinity may be determined using eigenvector centrality, degree centrality, etc, each calculated form a bipartite graph 315 in FIG. 3a.

Ω(t) is an R×I affinity matrix between agents i∈I and resources r∈R, at time point t, where ∀i∈I: Σ_{r∈R}Ω(t, r, i)=1.0. An Affinity Matrix is a matrix used to organize the mutual similarities between a set of data points. Typical examples of similarity measures are the cosine similarity and the Jaccard similarity. These similarity measures can be interpreted as the probability that two points are related.

N(t,r,i,j) is a fitness value for two agents i and j being in the same resource neighborhood at time point t.

### Neighbors

N(t, r, i, j)=Ω(t, r, i)∘Ω(t, r, j)

This calculation is made for a given time point tₓ. In this way, this assigns a fitness to how close two agents are during tₓ. Calculated neighborhood fitness values indicate a degree to which two institutions are similar to one another. The neighborhood fitness value tends to increase when two institutions exhibit an increasing number of artists in common in their immediate network. For example, if 80% of artists exhibited by one institution have a shortest path of 2 or less edges to another institution, those two institutions may be close to one another and considered in the same neighborhood.

For example, a “reliability” metric may be assigned that indicates, for a sequence of exhibitions for an artist that transitions from one institution to another, how likely it is that this transition is a direct result of one institution sharing the artist with the receiving agent over a given period of time. These institutions may be highly related (share many artists, be in close geographical proximity, exhibit the same genre, etc.) or highly unrelated (have few shared artists, be in different continents, exhibit artists of dissimilar genres, etc.). Based on this information, how likely it is that an artist is exhibiting at an institution specifically because the artist exhibited at another institution before, rather than by chance, may be determined. If not by chance, the two institutions intended to transition the artist from one institution to the other. Thus, the neighborhood score may capture the likelihood that a resource r transitions from agent i to agent j, because of the intent of i and j to collaborate together.

Fitness considers the proximity of each agent relative to their neighborhoods, A and B. If the agents are in close proximity, there is a higher likelihood they will share resources. As illustrated by FIG. 3d, resources can be shared between agents in the same neighborhood (intra-neighborhood share), and between agents in different neighborhoods (inter-neighborhood share). The affinity matrix 12 defines the closeness between two agents, where a higher affinity means agents are closer neighborhood.

For a historical time point tₓ₋₁ and a meeting time point tₓ, the fitness of the receiving agent not using the resource before time point tₓ₊₁ is calculated namely during tₓ₋₁ and tₓ time points. The time points and resource usage by agents are illustrated in FIG. 3d.

The model can include first-time use of a resource by an agent and exclude the re-use of a resource by an agent. The use of a resource is considered a re-use by the receiving agent if the resource was used during tₓ₋₁ and tₓ. If the lower-bound of tₓ₋₁ is infinity, the resource r was never used by agent j that is receiving the resource.

In this way, usage, history, and neighborhood values are determined to establish a population fitness at step 1300 in FIG. 1.

At step 1400 in FIG. 1, an intent trajectory is determined. Intent trajectory T(tₓ, tₓ₊₁, r, i, j) is a R×I calculated from a one-hot encoding matrix extracted from the two bipartite graphs 315, as depicted in FIG. 3a, for time points tₓ and tₓ₊₁, between the state of resources (305) r∈R and agents (300) i∈I at each time point. The score is higher if an artist exhibited at a first institution at tₓ ends up exhibiting at a second institution at tₓ₊₁. The score is normalized and divided by the total number of resources |R|. Method X∘Y is the Hadamard multiplication of two matrices X and Y.

$$Intent Trajectory$$

$$T ( {t}_{x} , {t}_{x + 1} , r , i , j ) = \frac{Π ( {t}_{x} , r , i )}{R} \cdot \frac{Π ( {t}_{x + 1} , r , j )}{R}$$

At step 1500, a fitness of a trajectory solution is calculated. For example, as an artist progresses in their career and exhibits their artwork at different institutions over time, their acclaim may change depending on the strategy they use in picking institutions. For instance, exhibiting at increasingly better institutions may raise the artists' acclaim. exhibiting at lesser institutions may lower their acclaim.

However, this may not always be the case, such as when an artist oversaturates the market with their artwork, i.e. “sells out,” and exhibitions at too many commercial galleries, and a more nuanced strategy might be needed. For example, an artist may diversify the type of institutions they exhibit at to increase their exposure at the beginning of their career. At later stages, they may focus on long term legacy associated with a meaningful cause, exhibiting at institutions related only by that cause. If these are intentional strategies, the transition from one institution to another is done through partnerships with institutions, for example making use of the relationships between institutions. Such relationships could be based on institution metadata, such as their curators, board of directors, or of the artist such as art dealers and art prices.

Where Ω(t, r, i) is an R×I affinity matrix between resource r and agent i, in time point tₓ. The intent trajectory fitness value \ddot{σ}(tₓ₋₁, tₓ, tₓ₊₁, i, j) is the probability of agent i intentionally sharing resource r with agent j in time point tₓ, as observed at time point tₓ₊₁. In an embodiment, \ddot{σ}(tₓ₋₁, tₓ, tₓ₊₁, i, j) represents the probability that an artist that has never exhibited at institution j has exhibited at institution j because the artist exhibited at institution i previously and i and j were close neighbors at that time. After summing over various resources that i and j have shared, intent trajectory fitness value \ddot{σ}(tₓ₋₁, tₓ, tₓ₊₁, i, j) is high if all the artists that institution i is sending to institution j have never exhibited up at institution j before at tₓ₋₁.

$$Intent Trajectory Fitness$$

$$\ddot{σ} ( {t}_{x - 1} , {t}_{x} , {t}_{x + 1} , i , j ) = {\sum }_{r ∈ R} [ H ( {t}_{x - 1} , r , j ) \cdot T ( {t}_{x} , {t}_{x - 1} , r , i , j ) \cdot N ( {t}_{x} , r , i , j ) ]$$

This calculation may be repeated not just for three intervals but over a longer period of time, as indicated by highlighted edges 365 in FIG. 3c. For each resource trajectory, the velocity and acceleration of rank resources over time may also be calculated.

This is illustrated in an example in FIG. 3d. As shown in FIG. 3d, there are two groups of neighborhoods, groups A and B, and three time points t₀, t₁, and t₂ which represent tₓ₋₁, tₓ, and tₓ₊₁. Group A includes institutions 1 and 2 and group B includes institutions 3, 4, and 5. At time point t₀, the artist has never exhibited at institutions 4 and 5 before. At time point t₁, an artist is exhibited at institution 1 and institution 3. At time point t₂, the artist is exhibited at institution 4. The calculation of \ddot{σ}(t₀, t₁, t₂, i, j) helps determine why the artist is exhibited at institution 4. For example, is the artist being exhibited at institution 5 because it was previously exhibited at institution 3, or because it was previously exhibited at institution 1? Because institutions 3 and 4 are in the same neighborhood, it is more likely that the artist is exhibited at institution 4 because the artist was previously exhibited at institution 3.

As shown in steps 1561, 1563, and 1560, the trajectory fitness is used for training a model. Embodiments will identify a model configuration that considers all information available that best predicts an artist's trajectory and ranking over time. For example, an intention trajectory that results in the increase of an artist's acclaim over 20 years may be identified. This may involve training a model that can identify patterns of institutions, where a pattern may include the types of institutions, the order in which the exhibitions occur, the duration between exhibits at each institution type, and the impact that such patterns have on the artist's acclaim. These factors are identified as parameters that make up a model's configuration and can be simple or complex. A model is considered complex when it considers several parameters and of different types, including Boolean, continuous, and thresholds. In one example, the model may be a long-term, short-term memory neural network. The model may be trained with known groups of institutions that are known to practice certain strategies to bolster values of artists. Once trained, the model may be applied to other institutions to understand their strategies. The model may also be used to predict what the known institutions would do in the future given different scenarios. These are discussed in more detail below.

For example, one scenario may indicate that larger museums in larger cities take five years to exhibit an artist after they have exhibited at commercial galleries of a certain genre outside of that city. The scenario may further indicate that this only happens if the museum has designated 20% of their space to such artists. This description includes how an institution type is defined (large size; museum; in a large city; 20% capacity for small artists external to city; etc.). Once such a pattern is identified, any transitions an artist makes in that five years is not consequential to them exhibiting at that large museum.

At steps 1561, 1563, and 1560 model parameters are selected. At step 1560, initial model parameters are selected. At step 1561, a machine learning model is trained to predict the sharing of a resource in t₂ by agent j. The trained model is evaluated for convergence with lower error. Finally at step 1563, the configurations of the model is restarted. The process is repeated until the model converges and a set of parameters is determined.

In particular, a “best” model is selected for a subset of model parameters, where the “best” model is one that produces the lowest error under convergence when compared to the ground truth. Model parameters include tₓ₋₁, tₓ, tₓ₋₁, as well as agent-specific and resource-specific characteristics, including their types and value v(r) if available. These characteristics are domain specific, but the methods presented here are domain agnostic.

At step 1600, a combination of model units is selected according to best model parameters and a calculated fitness of derived attribute values. For example, model units can be made up of parameters, the learning step identified as instrumental in identifying an artist's future acclaim, and assigned weights. This may include institution type, duration between exhibiting artists from an institution of a specific type, affinity between institutions, and so on.

Agent pairs i and j acting with intent are selected from tₓ to tₓ₊₁, given history in tₓ₋₁. For each agent pair, collect all timeframes from t to t_{T} where best model parameters are found.

If available, resource ranking velocity over time is calculated, referred to as Δv(r). If available, resource ranking velocity over time for agent pair i and j is calculated for all resources used by them, and referred to as Δv(Rᵢ∪Rⱼ). A positive value velocity means that agent i shares, and agent j receives, resources that gain value over the given time period. This means that agent i has a positive influence on the value of resources they share with agent j.

A negative value velocity means the resources they share lose value over the given time period. This means that agent i has a negative influence on the value of resources they share with agent j.

For each agent i, those that have a positive out-degree velocity from t to t_{T} are identified. These agents share resources more. For each agent j, those that have a positive in-degree from t to t_{T} are identified. These agents receive shared resources more.

If Δv(Rᵢ∪Rⱼ) is greater than zero and out-degree for agent i is high, agent i is thriving by sharing with agent j. If Δv(Rᵢ∪Rⱼ) is greater than zero and out-degree for agent i is low, agent i is thriving by not sharing with agent j. If Δv(Rᵢ∪Rⱼ) is greater than zero and in-degree for agent j is high, agent j is thriving by receiving resources from agent i. If Δv(Rᵢ∪Rⱼ) is greater than zero and in-degree for agent j is low, agent j is thriving by not receiving resources from agent i.

Collaboration occurs when two agents i and j share resources with each other in volumes. Meaning, the number of resources shared by i with j (R_{i,j}) is similar to the number of resources shares by j with i (R_{j,i}), where the collaboration rate definition is

|R_{i,j}|/|R_{j,i}|≅1.0.

If Δv(Rᵢ∪Rⱼ) is greater than zero between collaborating agents i and j, then these agents benefit from collaborating together. If Δv(Rᵢ∪Rⱼ) is less than zero between collaborating agents i and j, then these agents do not benefit from collaborating together.

For each agent, agent characteristics that form well-defined sharing clusters are identified. Given all combinations of model parameters of agents i and j, as well as resource r, clusters are formed along available dimensions used to calculate the distance between agents in clustering algorithm.

The dimensions can be based on a combination of ground-truth values and calculated values. For example, ground truth values include agent types and resource types. Calculated values include those obtained, including changing resource velocity Δv(Rᵢ∪Rⱼ) and collaboration rate |R_{i,j}|/|R_{j,j}|.

At step 1700, agent goals and subgoals are defined. For example, the basic goal of an institution that is a commercial gallery may be able to make money by selling artworks that increase in value. A set of subgoals towards that goal would be to: identify artists with potential of a high selling price (with history of increase in selling price); select artists that are available through the gallery's partner institutions; from this group, select artists that align with the gallery's network of art buyers (through similarity of artists exhibited in the past); secure the artist's commitment to an exhibit with artworks with high selling price potential within a network of buyers (an artist may commit their best work to competitors instead or work that does not align with potential buyers of the gallery); organize exhibit; and sell artwork. If any of these preconditions are not true, the exhibit may not occur.

In contrast, the basic goal of a larger museum may be to collect artworks that have long-term social significance. A set of subgoals then may be to: identify significant social movements (say an increased interest in female artists from South America); identify artists that fit this criteria; from this group, identify artists that have longevity potential (considering artists attributes like an Art History degree, residencies, history of large exhibitions, etc.); from this group, identify artists that have produced work that aligns with what the museum usually exhibits or is beginning to exhibit; ensure the exhibit fits within the portion of exhibits allocated to this type of artwork; secure the artwork; increase attendance; market the exhibit to the public; or display exhibit.

Note that a precondition may be based on Boolean, continuous, or threshold parameters. In the above example, whether an artist has an Art History degree can be represented as a Boolean parameter. In contrast, the long-term significance of an artwork may be represented as a continuous parameter, say on a scale between 0 and 1. Finally, consider the “fit criterion” that to be a good fit, an artist's exhibit must be made up of least 51% photographs. For an artist who has only 20% of their artwork as photographs and 80% as sculpture, the precondition is not met.

An agent can start off with a set of goals, say increase their own value in a network, and proceed to generate a plan to satisfy those goals.

Any preconditions that need to be satisfied first are referred to as subgoals. A precondition to increasing their own value may be the sharing of a resource with agent that have a higher value than theirs.

If they don't have direct access to such agents, they may need to find intermediate agents to pass a resource through that can reach the higher valued agent.

A chain of choices that satisfy a set of subgoals and the initial goal is called a plan.

Such subgoals and choices can be chained together, as defined by planning literature. Each chain starts with a goal, and each choice is meant to satisfy the preconditions towards that goal. A number of search algorithms can be used to find such subgoals and choices, including backward search, island search, and so on. If the starting point is in a subgoal bidirectional search algorithms can be used.

When an agent's actions increase their utility, they are assumed to be acting rationally. This is based on the standard neo-economic notion that rational agents maximize their utility. A caveat here is bounded rationality which states that rational agents maximize their utility within their cognitive bounds, available choices, and limited time. Agents use all abilities, cognitive, choices, and time, to their maximum abilities.

Hence the agents defined by this invention abide by the bounded rationality definition of rational agents, i.e. maximize utility within their means.

When agent i shares, not shares, receives, does not receive, or collaborates, and the Δv(Rᵢ) increases, they are maximizing their utility and are therefore acting rationally.

Maximizing utility may mean satisfying their goals. The invention does not require all underlying goals and subgoals to be predefined, only that at least one basic goal exists for the agent and can be defined within the target domain and context. Any intentional choices towards that goal are subgoals and are themselves rational. Hence, any intentional choices an agent makes which increase the value of resources to satisfy their goals can be inferred. For example, consider the underlying goal of increasing the value of resource r by sharing the resource with more valuable agents.

If agent i has this goal to share a particular resource r with agent j, a subgoal might be to obtain that resource first. This may be a precondition that must be satisfied by i before sharing r with another agent j.

At step 1800, a plan is decomposed through intention chaining. For some agent i that has a goal of sharing resources with agent j, a set of steps needed to satisfy that goal can be defined. If intentional choices \ddot{σ} made by agents are inferred, they may be chained together to construct a multi-step plan that includes shares through intermediate agents.

For each agent pair i and j, indirect sharing partner agents where the share is not directly between i and j but indirectly through one or more intermediate agents F are identified. Such a chain is depicted in FIG. 3c with highlighted edges 365, forming a chain between nodes 300e, 305e, 310e, 330e, and 320e, where 300e is the initiator of the chain and node 320e is the target of the chain, and all other edges are the intermediate nodes in the chain.

Here, the intent choices \ddot{σ} are chained by defining tₓ₋₁, tₓ, and tₓ₊₁ in partitions. Each agent k has associated partitions time points, p(fₖ, tₓ₋₁), p(fₖ, tₓ), and p(fₖ, tₓ₊₁). With two partitions, intermediate agent where f₀=F may connect agents i and j.

\ddot{σ}(p(i, tₓ₋₁), p(i, tₓ), p(f₀, tₓ₊₁), i, f₀) to \ddot{σ}(p(f₀, tₓ₋₁), p(f₀, tₓ), p(j, tₓ₊₁), f₀, j)

More generally, for agents i, j, and intermediate agents F, where size of F is |F|, a chain may be

$$\begin{matrix}\ddot{σ} ( p ( i , {t}_{x - 1} ) , p ( i , {t}_{x} ) , p ( {f}_{0} , {t}_{x + 1} ) , i , {f}_{0} ) , \\ \ddot{σ} ( p ( {f}_{0} , {t}_{x - 1} ) , p ( {f}_{0} , {t}_{x} ) , p ( {f}_{1} , {t}_{x + 1} ) , {f}_{0} , {f}_{1} ) , \\ … , \\ \ddot{σ} ( p ( {f}_{\vert F \vert - 1} , {t}_{x - 1} ) , p ( {f}_{\vert F \vert - 1} , {t}_{x} ) , p ( {f}_{\vert F \vert} , {t}_{x + 1} ) , {f}_{\vert F \vert - 1} , {f}_{\vert F \vert} ) , \\ \ddot{σ} ( p ( {f}_{\vert F \vert} , {t}_{x - 1} ) , p ( {f}_{\vert F \vert} , {t}_{x} ) , p ( j , {t}_{x + 1} ) , t {2}_{j} , {f}_{\vert F \vert} , j )\end{matrix}$$

Each partitioned \ddot{σ} model configuration can be learned independently by methods. Each chain is then constructed from independently derived intent trajectories.

With intermediate intents, it is not always the case that a resource is being introduced for the first time to an intermediate agent, as described previously. Hence, the historical time point t₀ can be zero in length.

At step 1900, counterfactual intentions are created. Counterfactual intentions are those intentions that did not occur but would have if some criteria were met. This criterion may be referred to as a “counterfactual precondition” to distinguish it from the preconditions described previously.

For example, an institution's basic goal may be to increase the value of an artist they represent. In this example, this institution, called the source institution, may have done this in the past by sharing their artist with institutions ranked higher than itself, called target institutions, and that are also in their neighborhood (as represented by a high affinity score). Preconditions for such a share may be that the target institution be interested in this artist and that the source institution have a relationship with that higher-ranked target institution (high affinity). Assuming that the target institution has a higher ranking and is interested (exhibits similar artists), the source institution would have shared the artist if it was in its neighborhood. Given that it is not in its neighborhood (has low affinity) the artist was not shared. Hence a goal counterfactual intent is sharing the artist if the two institutions had a relationship, but do not.

Note that a counterfactual intent can consider Boolean, continuous, and threshold preconditions. In the above example, the precondition of affinity is continuous based on a threshold if what constitutes a high enough affinity score to consider a target institution as “in the neighborhood”.

We may also consider counterfactual preconditions as a comparison between values. For example, consider the situation where the source institution decided to share with the target institution, say A, because it had a higher affinity score than another, say target institution B, all other preconditions being equal. Here, the counterfactual intent would be to share with B and the counterfactual precondition would be that the affinity score with B was higher than with institution A.

Now consider a scenario where the target institution decided to use a third institution as an intermediary, meaning one with which the source institution has a relationship with, and which in-turn has a relationship with the target institution. Here, sharing with the intermediary institution is a subgoal needed to be satisfied to satisfy the main goal of sharing with the target institution. The share would occur between the source and intermediary institutions first, in hopes of a share between the intermediary and the target institution in the future. Unfortunately, the intermediary institution does not exhibit this type of artist, if it did, it would exhibit the artist. The sharing of the artist between the source institution and the intermediate institution is an intermediary counterfactual intent.

Coincidently, the potential sharing of the artist between the intermediary and target institution is also an intermediary counterfactual intent, as it did not occur but would have if the condition was true, namely that the intermediary institution did exhibit these types of artists.

Similar to intent chaining in step 1800, by chaining such intermediate counterfactuals together, a counterfactual intent chain may be built. Counterfactual are scenarios that did not occur but would have occurred if some condition were true. For example, agent i did not share resource r with agent j because it did not have the resource. However, if i did have r, i would have shared it with agent j.

Counterfactual intentions are intentions that would have been chosen by an agent if some precondition was true.

Two types of counterfactual intents can be inferred by the model: goal counterfactual intent and intermediate counterfactual intent.

A goal counterfactual intent follows from the assumption that sharing a resource with some agent j will increase the value of that resource. If agent i had the opportunity to share a resource with j they would have done so. The fact that they did not is only because the preconditions to share that resource were not met.

An intermediate counterfactual intent is one that would be inserted if the goal intent was not possible, i.e., if the preconditions for the goal intent were not met. Hence, an intermediate counterfactual intent is one that satisfies a precondition to satisfy a goal intent.

There are also situations where more than one intermediate goal intents are required. In this case, each intermediate goal intent would have its own precondition. Each precondition would require a separate intermediate counterfactual intent that satisfies it.

Intermediate counterfactual intents can be chained together to produce a counterfactual plan, similarly to the process described in step 1800. Here, the preconditions fall into two types, “regular preconditions” and “counterfactual preconditions”.

Counterfactual preconditions can be Boolean and continuous. For Boolean preconditions, they can be true or false by definition, say that a resource is not available but if it was the sharing of it would be true. For continuous value, the counterfactual precondition may be true or false based on a threshold value, meaning they are true if a value falls below some threshold and false otherwise.

Regular preconditions are those described above with respect to step 1700. They would be satisfied by the preceding intents, counterfactual or regular, and are used to chain the intents together into a plan.

The execution of each intent in the plan does not satisfy counterfactual preconditions. The preconditions that are not satisfied by the preceding intents in the chain would need to be satisfied independently of the preceding intents. If they were satisfied, they would not be counterfactual intents.

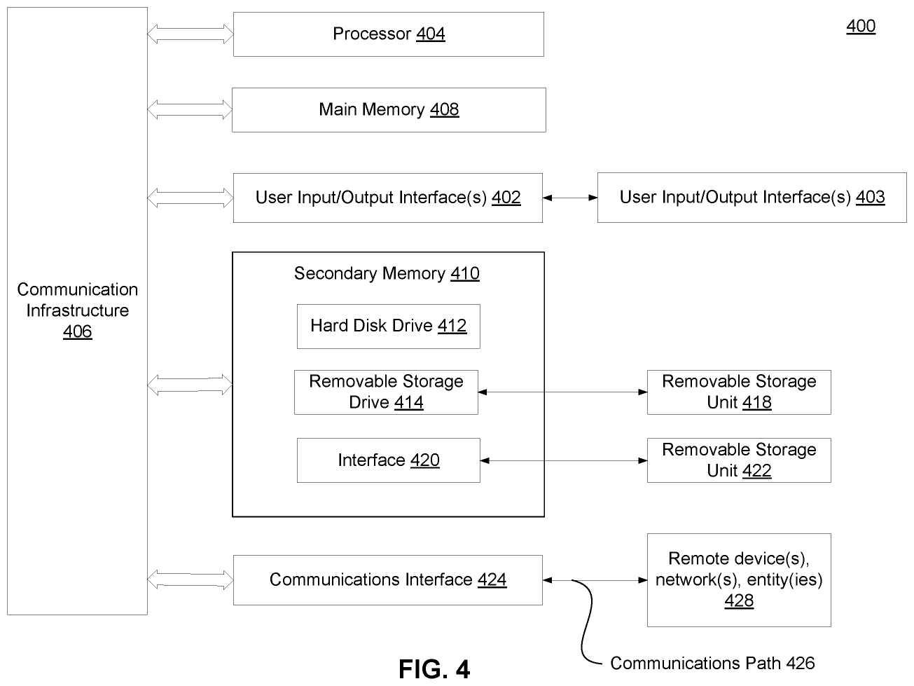

FIG. 4 illustrates an exemplary computer system capable of implementing the method for optimizing IT system infrastructure configurations according to one embodiment of the present disclosure.

Various embodiments may be implemented, for example, using one or more well-known computer systems, such as a computer system 400, as shown in FIG. 4. One or more computer systems 400 may be used, for example, to implement any of the embodiments discussed herein, as well as combinations and sub-combinations thereof. The computer system 400 may be used to implement the method described above with reference to FIGS. 1-3.

The computer system 400 may include one or more processors (also called central processing units, or CPUs), such as a processor 404. The processor 404 may be connected to a communication infrastructure or bus 406.

The computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 400 may also include a main or primary memory 408, such as random access memory (RAM). Main memory 408 may include one or more levels of cache. Main memory 408 may have stored therein control logic (i.e., computer software) and/or data.

The computer system 400 may also include one or more secondary storage devices or memory 410. The secondary memory 410 may include, for example, a hard disk drive 412 and/or a removable storage device or drive 414. The removable storage drive 414 may be a floppy disk drive, a magnetic tape drive, a compact disk drive, an optical storage device, tape backup device, and/or any other storage device/drive.

The removable storage drive 414 may interact with a removable storage unit 418. The removable storage unit 418 may include a computer usable or readable storage device having stored thereon computer software (control logic) and/or data. The removable storage unit 418 may be a floppy disk, magnetic tape, compact disk, DVD, optical storage disk, and/any other computer data storage device. The removable storage drive 414 may read from and/or write to the removable storage unit 418.

The secondary memory 410 may include other means, devices, components, instrumentalities or other approaches for allowing computer programs and/or other instructions and/or data to be accessed by the computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 400 may further include a communication or network interface 424. The communication interface 424 may enable the computer system 400 to communicate and interact with any combination of external devices, external networks, external entities, etc. (individually and collectively referenced by reference number 428). For example, the communication interface 424 may allow the computer system 400 to communicate with the external or remote devices 428 over communications path 426, which may be wired and/or wireless (or a combination thereof), and which may include any combination of LANs, WANs, the Internet, etc. Control logic and/or data may be transmitted to and from the computer system 400 via the communication path 426.

The computer system 400 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 400, the main memory 408, the secondary memory 410, and the removable storage units 418 and 422, as well as tangible articles of manufacture embodying any combination of the foregoing. Such control logic, when executed by one or more data processing devices (such as the computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

The claims in the instant application are different than those of the parent application or other related applications. The Applicant, therefore, rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A computer implemented method for intent elicitation in a social network with imperfect information, the method comprising:
gathering data representing the social network, the social network including a plurality of resources and a plurality of agents seeking to alter values of the resources;
representing the social network as a graph including nodes representing the plurality of agents, the nodes connected by edges specifying how resources are transferred between the agents;
based at least in part on the graph, determining an affinity value between respective agents in the plurality of agents, the affinity value representing a degree to which the respective agents and the agents surrounding the respective agents in the graph share common resources;
based at least in part on the graph, determining a trajectory value between the respective agents in the plurality of agents, the trajectory value representing a likelihood that a first agent in the plurality of agents presented a resource subsequent to a second agent in the plurality of agents; and
inputting the affinity value and the trajectory value into a trained machine learning model to identify a strategy of the plurality of agents, the strategy including at least one goal.

2. The method of claim 1, wherein each of the plurality of agents is an art institution and each of the plurality of resources is an artist.

3. The method of claim 1, wherein the determining the affinity value comprises determining a page rank.

4. The method of claim 3, wherein the determining the affinity value comprises determining a neighborhood fitness value N(t, r, i, j) for two agents i and j being in the same resource neighborhood at time point t, wherein the determining the neighborhood fitness value comprises:
determining a first affinity value Ω(t, r, i) representing an affinity of a resource r to the agent i;
determining a second affinity value Ω(t,r,j) representing an affinity of the resource r to the agent j; and
determining the neighborhood fitness value N(t, r,i,j) based on the first and the second affinity values.

5. The method of claim 1, wherein the determining the trajectory value comprises:
determining a one-hot encoding matrix Π(t) is a R×I for the usage of the plurality resources r∈R by the plurality of agents i∈I as
$$Π ( t , r , i ) = \{ \begin{matrix}1 ; & if r is used by i at t \\ 0 ; & otherwise\end{matrix} ;$$
and
determining the trajectory value T(tₓ, tₓ₊₁, r, i, j) for time points tₓ and tₓ₊₁ as
$$T ( {t}_{x} , {t}_{x + 1} , r , i , j ) = \frac{Π ( {t}_{x} , r , i )}{R} \cdot \frac{Π ( {t}_{x + 1} , r , j )}{R} ,$$
where R is a number of resources in the plurality of resources.

6. The method of claim 5, wherein the determining the trajectory value comprises determining a likelihood that a resource that has never been used by an agent j was used by agent j because the resource was previously used by the agent i and agents i and j were close neighbors at that time.

7. The method of claim 6, wherein the determining the trajectory value comprises:
determining a history value as
H(tₓ₋₁, r, j)=Π(tₓ, r, i)∘(I−Π(tₓ₋₁, r, j));
determining the likelihood as
\ddot{σ}(tₓ₋₁, tₓ, tₓ₊₁, i, j)=Σ_{r∈R}H(tₓ₋₁, r, j)∘T(tₓ, tₓ₊₁, r, i, j)∘N(tₓ, r, i, j)
where X∘Y is the Hadamard multiplication of two matrices.

8. The method of claim 1, further comprising:
repeatedly determining a plurality of trajectory values over a time period; and
inputting the plurality of trajectory values into a machine learning algorithm.

9. The method of claim 8, further comprises training the machine learning algorithm using change of value data.

10. The method of claim 1, wherein the strategy includes a chain of choices.

11. A non-transitory computer-readable device having instructions stored thereon that, when executed by at least one computing device, cause the at least one computing device to perform operations, the operations comprising:
gathering data representing a social network, the social network including a plurality of resources and a plurality of agents seeking to alter values of the resources;
representing the social network as a graph including nodes representing the plurality of agents, the nodes connected by edges specifying how resources are transferred between the agents;
based at least in part on the graph, determining an affinity value between respective agents in the plurality of agents, the affinity value representing a degree to which the respective agents and the agents surrounding the respective agents in the graph share common resources;
based at least in part on the graph, determining a trajectory value between respective agents in the plurality of agents, the trajectory value representing a likelihood that a first agent in the plurality of agents presented a resource subsequent to a second agent in the plurality of agents; and
inputting the affinity value and the trajectory value into a trained machine learning model to identify a strategy of the plurality of agents, the strategy including at least one goal.

12. The device of claim 11, wherein each of the plurality of agents is an art institution and each of the plurality of resources is an artist.

13. The device of claim 11, wherein the determining the affinity value comprises determining a page rank.

14. The device of claim 13, wherein the determining the affinity value comprises determining a neighborhood fitness value N(t, r, i, j) for two agents i and j being in the same resource neighborhood at time point t, wherein the determining the neighborhood fitness value comprises:
determining a first affinity value Ω(t, r, i) representing an affinity of a resource r to the agent i;
determining a second affinity value Ω(t,r,j) representing an affinity of the resource r to the agent j; and
determining the neighborhood fitness value N(t,r,i,j) based on the first and the second affinity values.

15. The device of claim 11, wherein the determining the trajectory value comprises:
determining a one-hot encoding matrix Π(t) is a R×I for the usage of the plurality resources r∈R by the plurality of agents i∈I as
$$Π ( t , r , i ) = \{ \begin{matrix}1 ; & if r is used by i at t \\ 0 ; & otherwise\end{matrix} ;$$
and
determining the trajectory value T(tₓ, tₓ₊₁, r, i, j) for time points tₓ and tₓ₊₁ as
$$T ( {t}_{x} , {t}_{x + 1} , r , i , j ) = \frac{Π ( {t}_{x} , r , i )}{R} \cdot \frac{Π ( {t}_{x + 1} , r , j )}{R} ,$$
where R is a number of resources in the plurality of resources.

16. The device of claim 15, wherein the determining the trajectory value comprises determining a likelihood that a resource that has never shown by an agent j showed at agent j because the resource showed at the agent i previously and agents i and j were close neighbors at that time.

17. The device of claim 16, wherein the determining the trajectory value comprises:
determining a history value as H(tₓ₋₁, r, j)=Π(tₓ, r, i)∘(I−Π(tₓ₋₁, r, j));
determining the likelihood as
\ddot{σ}(tₓ₋₁, tₓ, tₓ₊₁, i, j)=Σ_{r∈R}H(tₓ₋₁, r, j)∘T(tₓ, tₓ₊₁, r, i, j)∘N(tₓ, r, i, j)
where X∘Y is the Hadamard multiplication of two matrices.

18. The device of claim 11, further comprising:
repeatedly determining a plurality of trajectory values over a time period; and
inputting the plurality of trajectory values into a machine learning algorithm.

19. The device of claim 18, further comprising training the machine learning algorithm using change of value data.

20. The device of claim 11, wherein the strategy includes a chain of choices.
